(19) United States
(12) Patent Application Publication
(10) Pub. No.: US 2012/0132057 A1
(43) Pub. Date: May 31, 2012

(54) Generative Audio Matching Game System

(76) Inventor: Ole Juul Kristensen, Arhus C (DK)

(21) Appl. No.: 13/323,493

(22) Filed: Dec. 12, 2011

Related U.S. Application Data
(63) Continuation of application No. PCT/DK2010/050132, filed on Jun. 10, 2010.
(60) Provisional application No. 61/186,670, filed on Jun. 12, 2009.

(51) Int. Cl. G10H 1/38

(52) U.S. Cl. 84/650

(57) ABSTRACT

An audio matching method, use of the method in a game system, an audio matching system and a data carrier are provided, where the audio matching method is for comparing an input audio fragment with reference audio fragment variants, the method being an incremental search method, including repeating the steps of: obtaining a number of reference audio fragments variants on the basis of one or more stored audio fragments from a reference storage; and comparing the input audio fragment against the number of reference audio fragment variants to determine a comparison result; whereby repetition of the steps is carried out a predetermined number of times or as long as the comparison result improves.

### CROSS-REFERENCE TO RELATED APPLICATIONS

The present application is a continuation of pending International patent application PCT/DK2010/050132 filed on Jun. 10, 2010 which claims the benefit under 35 U.S.C. §119 (e) of U.S. Provisional Patent Application Ser. No. 61/186,670, filed on Jun. 12, 2009. The content of all prior applications is incorporated herein by reference.

### FIELD OF THE INVENTION

The invention relates to recognition of real electric or acoustic instrument audio signals, music games and music education systems.

### BACKGROUND OF THE INVENTION

Music games have become very popular. The genre covers games that are based on musical elements and require skills commonly associated with playing real music: rhythm, timing, co-ordination or reflexes.

Typically, a music game system will present a series of visual and/or sound events, as a song or stimulus to one or more players, who have to accompany or respond to the events. Typically, such games are played with proprietary controllers, which have sensors that make it easy for the system to track discrete events, the ‘what's being played’. Such controllers include buttoned guitar controllers, dance-mat controllers, and various kinds of drum- and beat-pads. The player events are compared to the events of the song or stimulus in real time and feedback is given to the player based on the discrepancy between his actions and the song, by visual effects, sound effects, points and statistics.

These games are aimed at entertainment, not meant to teach music or how to play real music. Indeed their educational potential is doubtful for several reasons:

First, the human motor function skills of handling an actual real music instrument are not at play because of the inherited limitation using controllers that are oversimplified simulations of real instruments. Singing, e.g. karaoke, through a microphone and, to some extent, drumming on pads are notable exceptions. Second, with simple controllers, playing real music score is not possible and the usual workaround is to oversimplify the music score as well. Hence, these music games will not teach how to play real songs. Third, playing controllers in current music games do not produce faithful sound, which is a shame since producing real music is a great motivation and reward that could compliment a game like high-score system.

Presumably all of the above is about to change, with a new generation of music games which can be played with real instruments, e.g. LittleBigStar, GuitarRising, Disney Star Guitarist, Guitar Wizard and Zivix. The turning point in the next generation music games is note- and chord-recognition of real audio from real instruments. Since guitars are very popular, most focus is on recognizing notes and chords from stringed instruments.

Audio Recognition

Researchers in the field of music information retrieval have effectively solved the problem of note recognition in monophonic audio in different ways. A common approach is to find note onsets in an audio stream and extracting the fundamental frequency of the signal shortly after the onset.

Conversely, the problem of chord recognition has been a researched extensively and found very hard to solve. Most research claim state of the art chord recognition methods of around 70% precision, when recognizing basic major and minor chords in polyphonic music.

Obviously, real song scores and tablatures go much beyond basic chords. As the typical purpose of a music game is to rate the players' performance against a reference score, it must be able to recognize any chord constellation which must appear in a real music score, including complex chord variations, e.g. as disharmonic chords, and chords which are varied over time, e.g. as in finger-play or arpeggio style. Further, it must do so very accurately to be educational. To this end, traditional chord recognition methods are nowhere near adequate.

Consequently, the trend in the next generation music games seems to solve the recognition problem physically in hardware rather than by software. For guitars, the obvious way to do this is by using the MIDI guitar technology that has existed for decades. MIDI guitars require special hexaphonic pickups, which translate each string (i.e. note) into a signal that can be analyzed as if it was a monophonic note signal. This way the problem of chord recognition reduces to note recognition.

Another physical solution is to add special sensors to a guitar fretboard to track finger placement and with this extra information, chords can be recognized. Indeed such augmented guitars are announced for a couple of new educational guitar products.

However, any physical, or partly physical, solution has several problems compared to a pure software approach.

First, a physical add-on may not be directly applicable to traditional and existing instruments, as it will require tinkering or physical modification of the physical instrument. Thus, this is out of range for most people and for precious instruments like many guitars.

Second, a physical solution will always be physically tailored to a particular type of instrument. Hence, different physical devices must be invented and produced for each supported instrument.

Third, physical solutions are costly to manufacture.

Jam Session Games

A jam session is usually understood as a musical improvisation, which develops spontaneously as a kind of musical dialogue among musicians. A game based on the jam session idea, has one or more players with an initiative to produce sound that one or more players have to respond to. The initiative shifts forth and back among the players.

One special case of a jam session is music battling, where the aim of the session is to play something that other players fail to repeat and some tracking of how players perform and ultimately win the battle. This is analogues to real rock concert guitar battles.

In another special case of a jam session, one player stay in control, and others could keep responding. This is analogues to a real teaching session where a teacher plays a small performance of music ranging anywhere from a single note to a few riffs, to an entire song, and the students repeat it.

While some arcade computer games exist with similar game principles, it is not accomplished for a real instrument game system. Indeed the system is relatively straightforward to implement in an arcade game system where inputs on discrete controllers can be perfectly tracked. Obviously, an arcade game jam session is a simulated jam session. It can be entertaining but it does neither teach handling a musical instrument nor playing music.

With real electric and acoustic instruments, however, a general jam session game system is impossible to implement with known audio recognition methods because it requires near perfect audio recognition of a variety of real instruments, playing styles and intonations.

Feedback Mechanisms

Typically, music games adopt familiar game feedback mechanisms, such as visual effects, sound effects and a point system. For example, visual explosion effects when a note has been hit and points are given for the hit.

These feedback mechanisms are familiar to computer gamers, but are not very useful, e.g. when actually learning to master an instrument and play songs, or when more detailed feedback is desired.

Visualizing Music Score

Real music score is rich on symbols. Measure and notes are most important, but current music games typically oversimplify the music score to a subset of real sheet music. Various kinds of visualizing music scores have appeared, most of them also incorporated in LittleBigStar, and they all have in common to use scrolling or movements of notes at the cost of readability. When notes move relatively fast over a screen, it is very difficult to read music symbols found on real music score sheets. Consequently, common music games only visualize a simplification or a small subset of traditional music score, like notes and measure bars.

Oversimplified score is a barrier to the educational aspects of a music game. One solution to solve the readability problem is to slow note movement down, but this makes notes come closer together to a point where they are hard to distinguish and clutters the presentation.

### SUMMARY OF THE INVENTION

### Object of the Invention

An object of the present invention may include one or more of the following provisions of:
A generic audio recognition software solution enabled to recognize notes, non-pitched beats, chords and any or several variations over chords with high precision and robustness.
A generic audio recognition software solution enabled to recognize notes, non-pitched beats, chords and any or several variations over chords from a variety of music instruments and precise enough to cope with intonation diversity.
A music game system incorporating a generic audio recognition software solution enabled to recognize chords.
A generic, instrument-indifferent audio recognition software solution.
A music game system using real instruments and enabling new jam session game play models.
A music game system providing new educational feedback mechanisms that make it easier, faster, and more fun for a player to actually learn to master an instrument and play songs.
A music score visualization, which is comprehensive, yet very readable.
A music score visualization for guitars, which does not require symbolic note data.

The present invention relates to an audio matching method for comparing an input audio fragment IAF derived from a real instrument RI with one or more reference audio fragments RAF, said method comprising the steps of: obtaining said one or more reference audio fragments RAF on the basis of a reference music context RMC and one or more stored audio fragments SAF from a reference storage RS, comparing said input audio fragment IAF against said one or more reference audio fragments RAF to determine a comparison result CR, and providing a representation of said comparison result CR to a user.

The present invention is advantageous in that it overcomes the limitations of the above prior art by a convenient generic software solution, which can recognize notes, non-pitched beats, chords and any variations over chords with high precision and robustness from a variety of music instruments and precise enough to cope with intonation diversity.

For clarification, the understanding of certain terms in the context of the present invention is defined in the following:
A real instrument is an acoustic or electric music instrument that can produce sound.
A beat is a non-pitched sound as produced by a real instrument.
A note is a tone as produced by a real instrument.
A note type is a class of notes where each note differs by octave but have same name in the chromatic scale.
A chord is a set of notes sounding concurrently, whether having same onset or overlapping through time.
Audio is a data-representation of sound. The representation can be in various forms and domains, for example the time-domain or the frequency-domain.
An audio fragment is a short piece of audio.
Mixing is any process taking two audio fragments as input, resulting in a single audio fragment that carries characteristics of both input fragments.

The present invention is dedicated to playing real instruments along a real music context or in jam sessions in the form of relevant audio and visual stimulus, matching of a player performance with real music score and feedback mechanisms that encourage and assists the player to develop and improve his musical skills.

Certain aspects and options of the invention comprise one or more of:
A method that recognizes notes, beats, chords and chord-variations with a high precision, from a variety of real music instruments, based on generating and matching audio fragments.
A learning system, which makes it possible to fine-tune the system to recognize any instrument that can consistently produce notes, chords or beats.
Jam session game systems, like battling game systems, teaching game systems or song play game systems.
Feedback mechanisms, including dynamic slowdown, speedup, looping, music score-reduction or -intensifying depending on the performance of one or more players.
Playback and visualization of music score data, which either come from a real song music score or are generated dynamically in jam sessions.
Visualizations of music score which emphasize readability in order to present a traditional music score in all its richness.
Visualizations of music score using a live camera recording of a guitar fretboard, and augmented reality techniques to show the fingers of the player along the graphical targets of how fingers should move on the fretboard.

According to an advantageous embodiment of the present invention, said step of obtaining said one or more reference audio fragments RAF comprises mixing one or more of said stored audio fragments SAF.

Thereby is facilitated comparison of an input audio fragment with any combination of stored audio fragments. The main advantage of this is the possibility of generating audio fragments representing any possible chord simply by providing fragments representing each possible note of an instrument. This feature significantly increases, practically in the infinity, the usability, versatility and adaptability of the invention. For example, the system may ignore all common rules for making music and allow comparison of usually impossible or unthinkable combinations of notes, chords, beats or, in fact, sound.

According to an advantageous embodiment of the present invention, at least one of said stored audio fragments SAF is selected from a list of:
note representing audio fragments,
note pluck sound representing audio fragments,
note sustain sound representing audio fragments,
chord representing audio fragments,
partial chord representing audio fragments, and
non-pitched sound representing audio fragments.

According to an advantageous embodiment of the present invention, said step of obtaining said one or more reference audio fragments RAF comprises mixing one or more note representing audio fragments to form a chord representing audio fragment.

The recognition methods of the present invention are unique in being able to accurately recognize any chord or note constellation, from a variety of pitched instruments and recognize beats from a variety of non-pitched instruments.

The preferred recognition method has proven extremely accurate and robust for electric and acoustic guitars. It recognizes all notes in a chord by string and fret with very few errors. It recognizes and differentiates small variations over chords and has no problems with chords, which sounds very similar even to trained human ears, such as Am, Am7 and Fmaj7/A played near the neck on a guitar. It generally recognizes guitar chords, which are identical except for being played at two different places on a guitar fretboard. For example, an A played near the neck of a guitar on the 5^{th} fret or the 12^{th} fret.

Hence the recognition method rival costly and inconvenient physical solutions, such as e.g. MIDI Guitars. Whereas physical solutions are manufactured and bound to a particular type of instrument, the recognition method of the present invention is generic and needs no manufacturing. It works for practically any instrument and it needs nothing more from the user than plugging an electric instrument or a microphone into a computer. The methods even works for non-pitched instruments, e.g. drums, as well as pitched instruments, e.g. stringed instruments.

According to an advantageous embodiment of the present invention, one or more of said stored audio fragments SAF are established in said reference storage RS by a learning process prior to carrying out said method.

A learning method allows teaching sessions where some or all notes, chords or beats that can be produced by an instrument are taught to the system by the player. This makes it possible to fine-tune the system to recognize any particular instrument that can consistently produce notes, chords or beats. Further, it makes the recognition robust to any intonation and tuning characteristics that are inevitable in physical instruments.

According to an advantageous embodiment of the present invention, said reference music context RMC comprises music score events RME determined by a symbolic representation of a piece of music, e.g. a music score.

In a preferred embodiment of the invention, a symbolic representation of the music that the user is supposed to follow is provided to aid in choosing, and possibly generating, the reference audio fragments RAF that should be compared to the input audio fragment IAF from the user. A symbolic representation can furthermore easily form basis for visual cues to the user about what to play, i.e. displaying the notes or chords to play according to a chosen visualization scheme.

Even though preferred embodiments of the recognition methods of the current invention only detail how to match the onset and audio characteristics of notes, chords and beats, a preferred embodiment of the game visualize a full music score in all its richness and detail. This is advantageous because real music score can have educational value by itself and because it provides the player with detailed instructions of how to interpret a piece of music.

The player may not get explicit feedback on how he interprets smaller details, like hammering rather than picking a specific note, but it is encouraging to have the full score presented rather than a simplification of it. Part of this invention details a visualization of music score, which is comprehensive, yet very readable.

According to an advantageous embodiment of the present invention, said reference music context RMC comprises reference music audio RMA comprising an audio representation of music determined by a real music data stream from a digital medium.

As an alternative to symbolic representation, a piece of music which is pre-recorded, generated/synthesized or played live at runtime, may form basis for establishing the reference audio fragments RAF to compare with the input audio fragment IAF from the user. This unique feature facilitates using any music that is available e.g. from compact discs or digital music files such as MP3-files, or is performed right away during the session, regardless of a symbolic representation being available or not. This increases the usability of some applications of the present invention, as it may be difficult to obtain a symbolic representation, e.g. a music score, for a particular piece of music, and obviously is unfeasible when if reference music is composed simply by playing it at runtime.

According to an advantageous embodiment of the present invention, said reference music context RMC is determined from a lead input audio LIA derived from a lead real instrument LRI.

The lead input audio is in this embodiment considered a reference music context RMC, and may be translated into reference music events, reference music audio or be used directly a reference audio fragments to compare with the user-generated input audio fragments.

The game systems detailed in some embodiments of the present invention are characterized as jam session game systems. Contrary to well-known arcade game systems, the jam sessions in mind are in fact real jam sessions, in virtue of being played with real instruments which makes real sound and require real musical skill. Special cases of jam session game systems include instrument battling game systems, teaching game systems or song playing game systems.

The recognition methods' support of practically any instrument is a valuable feature since jam sessions are often based on spontaneous music improvisation and prosper from instrument freedom (like clapping hands or drumming on a barrel). To the contrary any physical solutions to the audio recognition problem described above are locked to specific manufactured instruments or devices.

The present invention makes it possible to assist or augment a real jam session with one or more computer systems which tracks the performance of each player and gives valuable feedback, about how well each player performs and invoke happenings as punishments or reward.

It is within the scope of the present invention that players of a jam session need not reside at the same physical location, but can be connected via a network, like the internet.

According to an advantageous embodiment of the present invention, said step of providing a representation of said comparison result CR to said user comprises performing a step of adjusting a rate at which subsequent reference music context RMC is presented to said user.

Providing feedback to the user by adjusting the speed or density of events of the music that the user has to respond to provides several advantages. Different types of feedback mechanisms, punishment or reward are detailed which do not only provide feedback on the players' performance but trigger game events that make it easier for a player to actually learn to master an instrument and play songs. Thus, feedback mechanisms promote the educational aspects of the game systems.

In a special case of a jam session game system, feedback is based on how well a player follow real music score, but rather than only giving points or statistics, bad performance of the player triggers a slowdown of the song, making it easier to follow. Conversely, good performance triggers a speedup of the song, ensuring that the players' music skills are constantly challenged.

According to an advantageous embodiment of the present invention, also referred to as basic generative audio matching, GAM, said method comprises the further steps of: monitoring an audio signal from said real instrument RI to detect an onset, upon detection of an onset, determining if it substantially coincides in time with a reference music event RME, upon substantial coincidence in time between an onset and a reference music event RME, carrying out said steps of obtaining said reference audio fragments RAF, comparing said input audio fragment IAF therewith, and providing said representation of said comparison result CR to said user.

A more detailed explanation of the basic generative audio matching GAM system is given below, including its advantages.

According to an advantageous embodiment of the present invention, also referred to as extended generative audio matching, E-GAM, said method, in case said comparison result CR fulfils a predetermined success criterion, comprises the further steps of: generating a number of audio fragment variants on the basis of variants of said reference music event RME and said stored audio fragments SAF, comparing said input audio fragment IAF against said audio fragment variants to determine a comparison result CR, and providing a representation of said comparison result CR to said user.

A more detailed explanation of the extended generative audio matching E-GAM system is given below, including its advantages.

According to an advantageous embodiment of the present invention, also referred to as bottom up generative audio matching, BottomUp-GAM, said step of obtaining said one or more reference audio fragments RAF comprises: generating audio fragment variants for two-note chord constellations on the basis of said stored audio fragments SAF representing simple notes, generating audio fragment variants for three-note chord constellations on the basis of said two-note chord constellations, generating audio fragment variants for four-note chord constellations on the basis of said three-note chord constellations, comparing said input audio fragment IAF against said audio fragment variants to determine a comparison result CR, and providing a representation of said comparison result CR to said user.

Other generative audio recognition methods come in variations over the same idea of matching input fragments of audio with fragments of audio learned from the teaching session with a particular instrument, and/or fragments of audio automatically generated from the learned audio fragments to represent any chord or note constellation.

Different variations of the recognition methods put different requirements to the computational hardware. The least computationally intensive variations of the recognition methods can be executed in real time on limited devices such as smartphones, PDAs or mini-computers. The most accurate methods are perfectly suited for hardware as found in personal computers and gaming consoles.

The family of recognition methods are named generative audio matching and may be a significant contribution to the general research field of music information retrieval, but the subject matter of a preferred embodiment of the invention is various new game systems based on generative audio matching techniques.

The present invention of an accurate and robust audio recognition system for a variety of real instruments opens up for a variety of game system models, which are both musical educational and entertaining. Several variations over the game system can be featured to meet various educational and entertainment ends.

In this context, a game system is a process that presents reference music events as visual or sound stimulus to one or more players who can respond to these events by playing their instruments and getting various kinds of feedback depending on how well their input audio corresponds to the reference events.

The present invention further relates to the use of an audio matching method according to any of the above in a game system, preferably comprising a personal computer or a game console.

The present invention further relates to an audio matching system comprising a reference store RS comprising one or more stored audio fragments SAF, a reference music context RMC, a reference audio generator RAG arranged to establish one or more reference audio fragments RAF on the basis of said reference music context RMC and one or more of said stored audio fragments SAF, a real instrument processor RIP arranged to establish one or more input audio fragments IAF on the basis of an audio signal from a real instrument RI, and a comparison algorithm processor CA arranged to receive said input audio fragments IAF and said reference audio fragments RAF and determine a comparison result CR on the basis of a correlation thereof.

According to an advantageous embodiment of the present invention, said reference audio generator RAG cooperates with a chord generator CG to generate reference audio fragments RAF, preferably representing chords, by mixing stored audio fragments SAF, preferably representing notes.

According to an advantageous embodiment of the present invention, said system further comprises a learning system arranged to store input audio fragments IAF established by said real instrument processor RIP as stored audio fragments SAF in said reference store RS.

According to an advantageous embodiment of the present invention, said reference music context RMC comprises reference music events RME comprising music score events determined by a symbolic representation of a piece of music, e.g. a music score.

According to an advantageous embodiment of the present invention, said reference music context RMC comprises reference music audio RMA comprising an audio representation of music determined by a real music data stream from a digital medium.

According to an advantageous embodiment of the present invention, said reference music context RMC is determined from a lead input audio LIA derived from a lead real instrument LRI.

According to an advantageous embodiment of the present invention, said system is arranged to carry out an audio matching method according to any of the above.

The present invention further relates to a data carrier readable by a computer system and comprising instructions which when carried out by said computer system cause it to perform an audio matching method according to any of the above.

### BRIEF DESCRIPTION OF THE DRAWINGS

The invention will in the following be described with reference to the drawings where

FIG. 1 illustrates chord generation according to an embodiment of the present invention;

FIG. 2 illustrates a preferred embodiment of a generative audio matching system according to the present invention;

FIG. 3 illustrates a learning system according to an embodiment of the present invention;

FIG. 4 illustrates a generative audio matching algorithm according to an embodiment of the present invention;

FIG. 5 illustrates an extended generative audio matching algorithm according to an embodiment of the present invention;

FIG. 6 illustrates a bottom-up generative audio matching algorithm according to an embodiment of the present invention;

FIG. 7 illustrates a jam-session setup according to an embodiment of the present invention;

FIG. 8 illustrates a jam-session setup according to an embodiment of the present invention;

FIG. 9 illustrates an embodiment of music event visualization according to prior art; and

FIG. 10 illustrates an embodiment of music event visualization according to the present invention.

### DETAILED DESCRIPTION OF THE INVENTION

As mentioned, chord recognition is considered a very hard problem. There is a vast body of research devoted to the problem, which tends to try to solve the problem by extracting frequencies or pitches from the input signal.

A preferred embodiment of the present invention builds upon a new system and method that does not attempt to find frequencies or pitch information in audio data and does not attempt to extract note information from chords. Instead of extracting pitch from an input audio signal, relevant audio signals are generated from known or previously learned reference signals and these signals can be compared to the input audio signal.

More specifically, generative audio matching according to a preferred embodiment of the present invention works as illustrated in FIG. 2, by matching incoming audio fragments IAF of a real instrument RI against learned and/or generated reference audio fragments RAF, each of which are simply a small carefully chosen piece of an audio signal.

In a preferred implementation, all audio fragments are audio signals of 93 milliseconds duration, represented in the frequency domain as a series of DFT bins. In a standard 44100 Hz signal this is equivalent to an audio buffer of 4096 samples. The sample buffer is transformed into a magnitude spectrum in the frequency domain using a discrete Fourier transform. Naturally, other transformations, domains and choices of audio fragment sizes can be used and generally, the optimal representation depends on the sound characteristics of the type of instrument in question. It is within the scope of this invention that an audio fragment could include phase information or be represented in an entirely different domain.

The input audio signals, either in the learning occasion where notes or chords are taught to the system by playing them on an instrument, or in the runtime occasion where the played audio should be compared to the taught or generated audio fragments, are preferably input to the system via a simple computer audio line input, or, in the case of acoustic instruments, via a computer microphone input. Other embodiments within the scope of the present invention provide dedicated, high quality sound cards or e.g. digital signal processors or any other processing means capable of receiving audio, either acoustically, analogous or digitally, and transmit it to the system, preferably as a digital audio signal. In other words, a real instrument processor RIP, being any suitable processor, e.g. simply a computer sound card with a suitable software driver, transforms the real instrument input into an input audio fragment IAF.

The reference audio fragments RAF are preferably based at least partly on stored audio fragments SAF, which in different embodiments are either taught to the system or automatically generated by the system, or combinations thereof. Automatically generated fragments can be generated prior to using the system or in between sessions, e.g. by the manufacturer or by the user, or they can be generated at run time during use of the system.

In a preferred embodiment, all simple notes are taught to the system and any chord constellation fragment can be generated on the basis of these note fragments by a chord generator CG. It is possible to use a set of predetermined audio samples instead of teaching; however, the teaching method has a unique advantage: it makes it possible for an end user to tune the system precisely for the sound of a particular instrument, as long as the instrument can produce notes or beats consistently. Further, this approach solves the problems of intonation, as the teaching of particular notes of a particular instrument calibrates the system with the exact intonation characteristics of that instrument.

Naturally, the number of simple note fragments that should be taught to the system to work can be varied according to the instrument type, the desired range of detectable chords, and the desired quality of recognition. For a guitar, the entire guitar fretboard of about 6*22 finger-/note-positions can be taught for most accurate results. A full size piano has usually 88 keys, producing single note sounds, which can be taught.

The stored audio fragments SAF need not necessarily to represent notes. A better, but also computationally harder choice is that some stored audio fragments represent parts of a note. For example, a simple guitar sound can roughly be classified as either a note pluck sound or a note sustain sound and the RS database can contain sounds of both plucks and sustain for all simple notes.

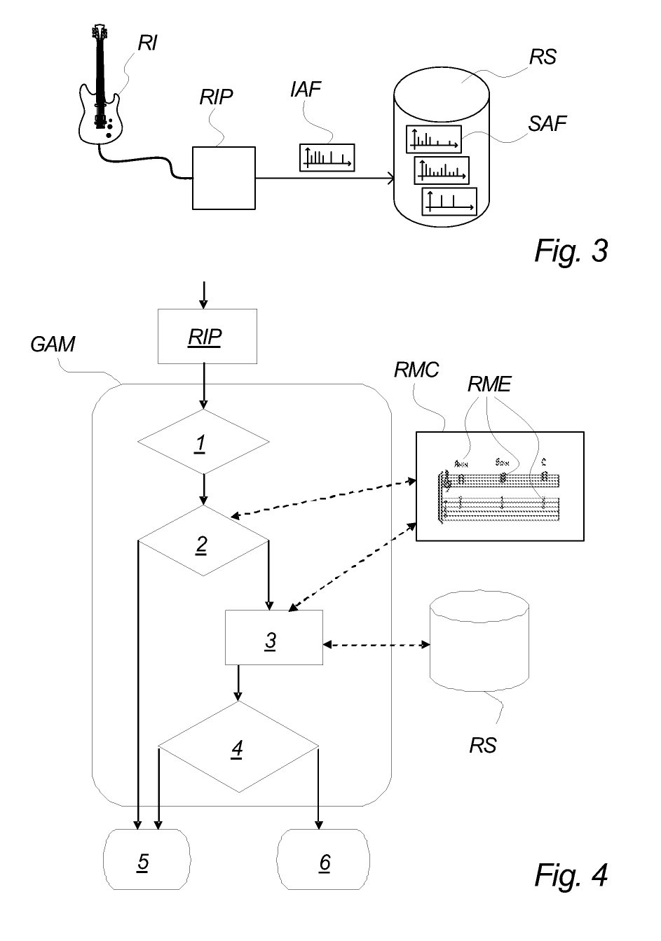

In a preferred embodiment, the game has a teaching mode, illustrated in FIG. 3, which allows a user to calibrate the system to his instrument. The system queries the user to play a single note on a real instrument RI. Then it awaits an onset in the input signal, as described in more detail below. Upon detection of an onset, the system captures one or more input audio fragments IAF by means of a real instrument processor RIP as described above, transforms it into the frequency domain, stores and indexes it in a reference storage RS as stored audio fragments SAF representative for the note queried.

The exact time span from onset to capturing a fragment can be important and varies for different types of instruments. For guitars, the string gets into a stable state a little while, e.g. roughly 30-50 milliseconds, after the onset pluck, depending on the pitch of the particular note.

The above procedure is repeated for some or all relevant single notes and/or beats that can be played by the instrument. This yields an indexed dictionary of audio fragments, representative of preferably all relevant simple notes for a particular instrument. For a guitar, this could be each simple note on each string—roughly 22*6=132 entities. The dictionary is stored in a storage medium RS for use in future sessions.

Compositional properties of sound make it possible to generate any chord fragments by combining note fragments, for any chord constellation, even dynamically in real time. This is fundamental to a preferred embodiment of the invention. As valid finger positions on a guitar fretboard account for more than 100,000 different chord constellations, it is not at all obvious how to handle so many audio fragments to recognize the input audio fragments IAF in real time. It is accomplished with generative audio matching approaches which are detailed further below.

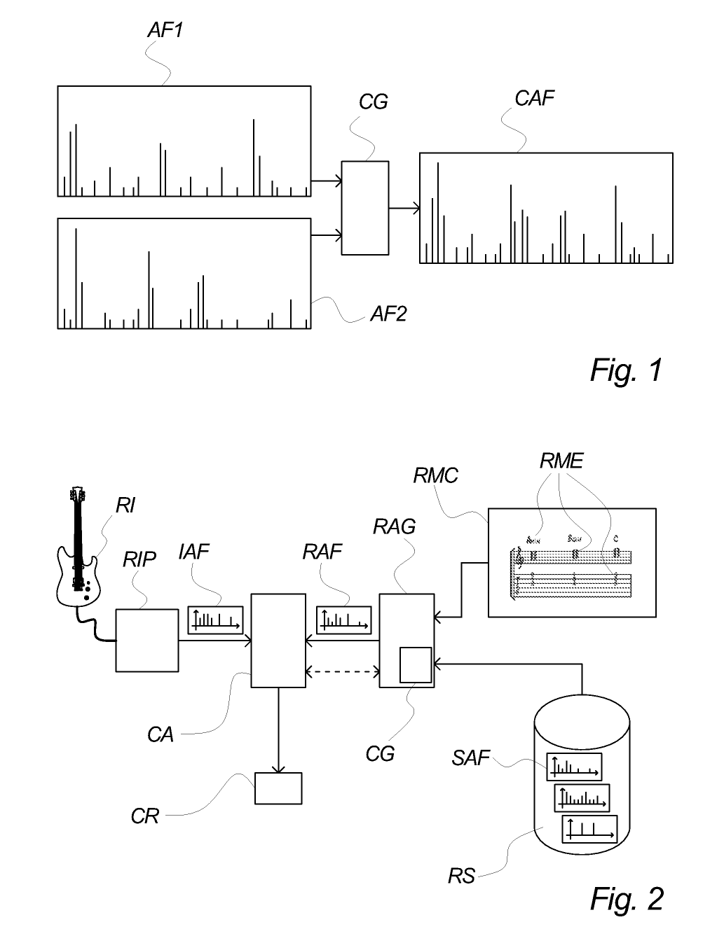

In a preferred embodiment, illustrated by FIG. 1, a chord audio fragment OAF, i.e. the reference audio fragment representative of a chord is generated by a chord generator CG by mixing audio fragments AF1, AF2, . . . representing all notes in the chord into one audio fragment such that every DFT bin of the chord audio fragment equals the maximal of the corresponding note audio fragment DFT bins. It is noted that the chord generator in a preferred embodiment may take any necessary number of audio fragments to mix into one chord audio fragment, e.g. at least 4 note representing audio fragments to generate a D7 chord audio fragment, and that any suitable mixing scheme is within the scope of the invention. The audio fragments preferably represent notes, but may also represent chords or non-pitched beats. In fact, a chord may within the scope of the present invention also be generated from a partial chord and one or more notes, e.g. a D7 chord may be generated by mixing a D chord audio fragment and a C note audio fragment. It is further noted, that in the context of the chord generator CG of the present invention a chord simply denotes a mix of concurrent audio, and therefore also refers to e.g. a mix of two different, concurrent drum beats, or a combination of a pitched and non-pitched audio. In other words, the chord generator CG may be employed for generating any reference audio fragment by mixing any relevant audio fragments.

Returning to FIG. 2, the chord generator CG is preferably part of a reference audio generator RAG responsible for creating the reference audio fragment RAF that would be relevant to compare with the input audio fragment IAF. The reference audio generator RAG preferably can make use of information from a reference music context RMC to do so.

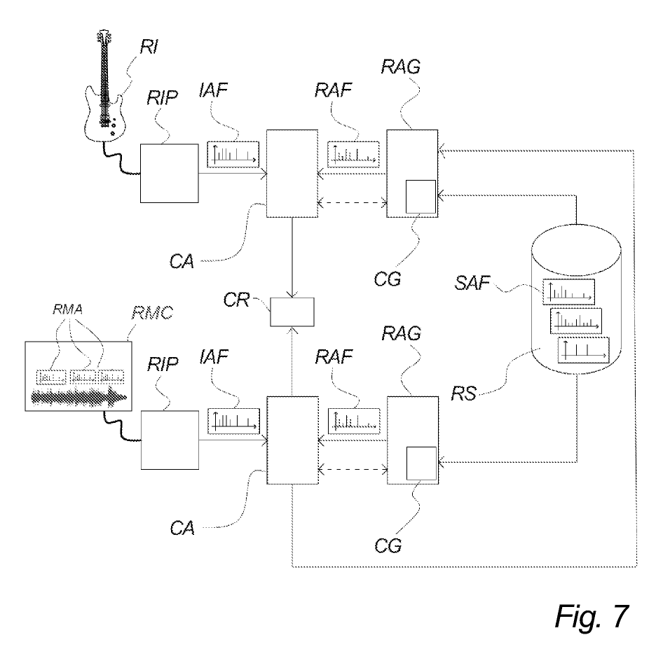

The reference music context can be useful for a variety of tasks. Most importantly it constitutes the reference music context that the player should try to reproduce on the real instrument, but the reference music context can also provide very useful information for the reference audio generator to narrow the search space and generating relevant information as detailed further below. The reference music context can be represented as reference music audio RMA in a time- or spectral-domain e.g. in an embodiment as illustrated in FIG. 7, or as reference music events RME in a symbolic note domain e.g. in an embodiment as illustrated in FIG. 2. Any other combinations of the embodiments of the present invention with either reference music audio or reference music events or a mix thereof may be feasible and are considered within the scope of the present invention. Such combinations include e.g. changing the embodiment illustrated in FIG. 2 to use reference music audio for the reference music context, or changing the embodiment of FIG. 7 to use reference music events for reference music context.

The reference music context is preferably also conveyed to the player, e.g. as visualizations on a computer screen and/or sound through speakers.

In accordance with the reference music events, in the embodiment of FIG. 2, the reference audio generator establishes reference audio fragments for comparison with the input audio fragments. In some cases, the reference audio generator may use a stored audio fragment SAF from the reference storage directly. In other cases the reference audio generator needs to generate the reference audio fragment from several stored audio fragments by means of the chord generator as described above. In an alternative embodiment, the reference audio generator may also receive information or audio fragments from other sources for use directly as reference audio fragments or for mixing with stored audio fragments.

A control link may exist between the comparison algorithm processor CA and the reference audio generator RAG, indicated by the dashed line. This link makes it possible for the comparison algorithm to make inquiries to the reference audio generator, e.g. in order to gain knowledge of possible notes, chords, etc., or in order to request the generation of certain reference audio fragments. Different ways for the reference audio generator and comparison algorithm to work together using this control link constitutes different generative audio matching methods, which are described in detail below.

As an important example, the control link is used in the case of the below-described extended generative audio matching method or bottom-up generative audio matching method or variations thereof, where the input audio fragment is in turn compared with several different reference audio fragments, to select the most relevant reference audio fragments to be matched against the input audio fragment.

In case the stored audio fragments represent partial notes, like guitar plucks and guitar sustain, the reference audio generator can apply logic like only to consider a sustain sound for a simple note if a pluck-sound of the same note was recognized recently, within a few milliseconds.

Most importantly, this setup makes audio fragments available that represent any note or chord as learned or generated data, and any audio fragment can be matched against any other note or chord fragment, as explained in further detail below. In particular, any input audio fragment IAF can be compared to some or all relevant reference audio fragments RAF to test for the best possible match by a comparison algorithm CA, producing a comparison result CR.

Matching Audio Fragments

Audio matching is extensively researched and several audio matching methods are well known. In a preferred embodiment, the comparison algorithm CA is an audio matching method that yields a number reflecting the similarity between the input audio fragment IAF and one or more reference audio fragments RAF.

A few examples of audio matching methods are presented here which are conceptually simple, computational efficient, yet performing reasonably well. The first, inner square-root product, generally performs best.

All matching methods can be made to yield a relative matching value, used to find the best match among several match candidates. Some methods can further be extended to yield an absolute matching value, as a measure of similarity between two fragments. The last three methods below yield absolute matches.

In the following, f1 and f2 denotes the two audio fragments that are compared and the term bin refers to a DFT bin in the audio fragment.

Inner square-root product: f1 and f2 are multiplied, bin for bin, and a sum of the square root of each term is established as the matching result. The result is a real number, which reflects the matching of f1 and f2.
Inner products are known from matching filters, but surprisingly, square-rooted inner products yield remarkable results. It is also a welcomed advantage that matching signals this way consists of processing vectors with only a few simple arithmetic operations, i.e. multiplication, addition and square root, which can be processed very fast by modern CPUs or GPUs.

Spectral peak matching: The matching result is the size of the intersection set of peak matches in f1 and f2, divided by the size of the union set of all peaks in f1 and f2.

Chromagram matching: For every audio fragment, a chromagram representing half-tones in the chromatic scale can be calculated. The squared Euclidian distance of the 12 dimensional chromagram vectors for f1 and f2 divided by 12 is returned as the matching result.

Spectral differences: f1 and f2 are subtracted, bin for bin. The matching result is the sum of the magnitude of all resulting bins divided by the sum of the total magnitude of all bins of f1 and f2.

Onsets

Finding onsets, i.e. note beginnings, in musical signals is a problem, which has been extensively researched. One typical approach uses an onset function to map an audio buffer into a real value. For plucked instruments, like guitars, an onset function that weighs high frequency content over lower frequency content performs well. This function simply iterates the frequency spectrum, and adds each bin's magnitude multiplied by its frequency. When e.g. evaluating this through short, e.g. 6 milliseconds audio buffers, with 50% overlap, significant peaks in the resulting down-sampled signal are onsets. A dynamic threshold can be used to pick the most significant peaks.

For string instruments the matching can also function as onset function. Thus, in some embodiments where matching results for simple notes are computed anyway to find the best match for an input signal, those matching results can be tracked over time to find onsets as peaks in matching results.

Generative Audio Matching

In the following, different generative audio matching methods are described according to the above general description. The methods according to the present invention are more precise and robust at fine-grained recognition of chords than other known methods. Further, generative audio matching have a unique advantage over traditional chord recognition approaches because non-pitched instruments, such as drums or clapping hands, can be matched and hence recognized just like pitched instruments, such as electric or acoustic guitars or pianos, or even complex hybrids such as a human voice.

The generative audio matching methods may be new contributions to the general research field of music information retrieval, but the subject matter that is regarded as the invention is various applications such as new game, training or interaction systems based on generative audio matching techniques, which are detailed below in various implementations.

Although accurate instrument recognition has many applications, it is perfectly suited for game-like systems, which have to provide very precise feedback to the player about following of reference music events or reference music audio. Without the generative audio matching methods of the present invention, such game systems would be impossible or very imprecise in recognizing audio signals when more notes are sounding concurrently. The only available product of this kind, LittleBigStar, is a good example, which shows that even state-of-the-art pitch detection techniques are insufficient.

Generative audio matching techniques according to the present invention are also perfectly suited for augmenting jam sessions with game systems and feedback, because in virtue of the teaching method described above, they work with any instrument and are robust to instrument-particular intonation.

Basic Generative Audio Matching

FIG. 4 shows an embodiment of a basic generative audio matching GAM game system according to the present invention, which is a real time process that runs along a reference music context RMC. For this basic GAM system the reference music context is required to be represented in a symbolic domain, as information about reference music events RME, i.e. information about the type and time of the notes in the reference music context.

The GAM receives input audio fragments IAF through a connection to a real instrument processor RIP of the player. In a preferred embodiment, input audio fragments are received through buffers of 93 ms duration, with 50% overlap as described above. The buffer size, overlap and representation can be varied to suit a variety of instrument types.

Following FIG. 4, the system in step 1 iteratively detects onsets in the input signal. Whenever an onset occur, the system checks in step 2 if there is a reference music event to match against, i.e. whether a note or a chord should be played at approximately this time. If there is no such reference music event, i.e. that nothing should have been played at this time, negative feedback is given in step 5 for playing notes not present in the reference music context. Otherwise, if there is such a reference music event, the input audio fragment IAF is captured and matched in step 3 against the reference audio fragment RAF of the reference music event which was either taught to the system, pre-generated or can be generated on-the-fly from the taught data by the chord generator CG. If the match in step 4 of the comparison algorithm CA is satisfactory, e.g. better than a chosen threshold, e.g. 75%, positive feedback is given in step 6 for playing a correct note or chord at the correct time, otherwise negative feedback is given in step 5. The meaning of satisfactory here is an absolute matching percentage which can vary to accommodate different difficulty settings in the game or educational system.

The computational simplicity of the GAM method makes it feasible to implement such music game on small devices like mini-notebooks or smartphones. Only whenever a note or chord event is coming, the corresponding audio fragment needs to be generated and matched against the audio fragment of the input audio, which is computationally very simple.

Importantly, the framework works with any kind of signal captured from any music instrument and there are only a few instrument-specific parameters such as the choice of matching- and onset-functions.

The basic GAM system is superior to the best currently known software approach implemented in LittleBigStar at recognizing chords and it requires less computational power. It has a major shortcoming in the absolute matching, but this can easily be overcome with the extension below.

Extended Generative Audio Matching

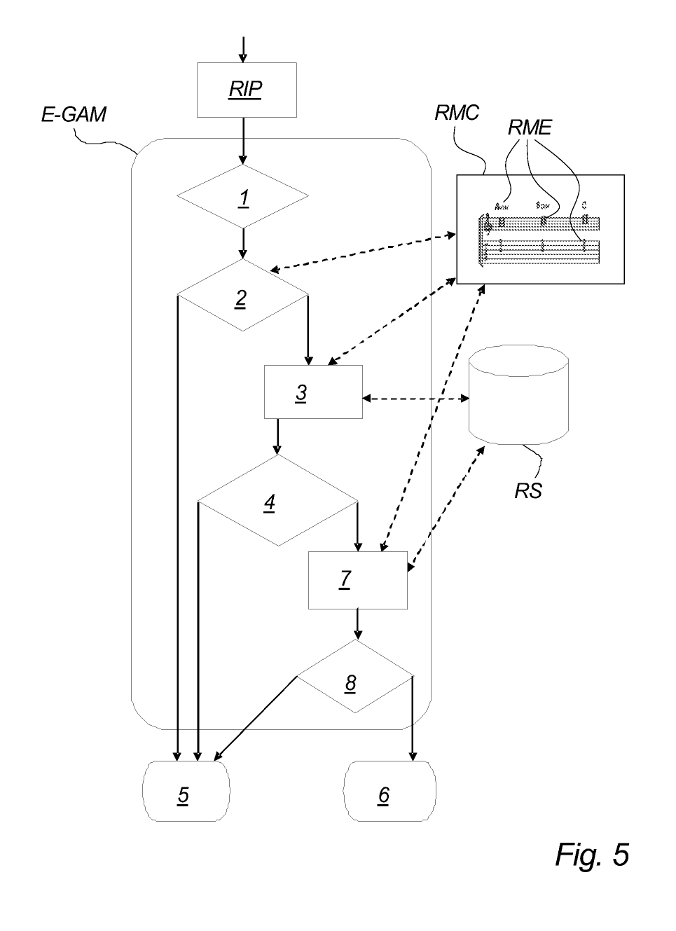

FIG. 5 shows an extension to the basic GAM game system, hereafter named E-GAM, which instead of relying on an absolute matching percentage threshold, takes advantage of relative matching to give very accurate positive and negative feedback. Contrary to GAM, the E-GAM gives positive feedback only when a match is likely to be close to an optimal match.

Like GAM, the E-GAM algorithm starts with finding onsets in step 1, and upon an onset determines, in step 2, if the user was supposed to be playing anything. If so, it compares in step 3 the input audio fragment IAF with a reference audio fragment RAF that represents what the user was expected to play based on the reference music events, and determines in step 4 if negative feedback is to be given. However, it differs from GAM in that before giving positive feedback in step 6, the system in step 7 generates a carefully chosen set of note and chord fragments, to find other reference audio events that even better matches the input audio fragment than the expected reference audio fragment. If there are better matches as determined in step 8, the played note, beat or chord is not an optimal match and the procedure continues at step 5 by giving negative feedback. Otherwise positive feedback is given in step 6.

Finding better matches this way is a search problem and finding an optimal match in a search space is a global maximum search problem. For a guitar fretboard the number of feasible finger positions exceeds 100,000 chord constellations and it has shown that even with powerful computational hardware it is feasible to search through, i.e. generate and match, only a few hundreds of possible chord constellations for the optimal match at very small time intervals.

Surprisingly it turns out that a small local search within the neighborhood of any given chord is very adequate, provided the search neighborhood is carefully chosen. In a preferred embodiment, the search neighborhood of a reference chord is chosen as the set of chord variations of the reference chord that are either missing one note or having an additional note type compared to the reference chord. This choice of search neighborhood is exemplified below.

Assuming that a chord maximally consists of 6 note types of the chromatic scale, there are maximally 6 variations that are missing one note type compared to the reference chord. For example, if the reference chord based on the music score event is a C major triad chord, which consists of C, E and G note types, there are 3 variations missing one note type: a chord consisting of C and E, one consisting of C and G, and one consisting of E and G. Moreover, there are 12 chord variations that emerge by adding one of the 12 note types in the chromatic scale to the reference chord. In fact, as up to 6 note types of the chromatic scale are already present in the reference chord, it could in an embodiment of the invention suffice to only consider the variants where only the 6 to 12 note types not already present in the reference chord are added. In the above example of the reference chord being a C chord, there are 9 variations with an added note type: C, E, G and C#; C, E, G and D; C, E, G and D#; C, E, G and F; C, E, G and F#; C, E, G and G#; C, E, G and A; C, E, G and A#, and C, E, G and B. In total, this amounts to maximally 18 variations of the reference chord, which are then all generated and matched against the input fragment. If none of these variations match the input fragment better than the reference chord itself, E-GAM gives positive feedback. Contrary, if any of the variations turns out to be a better match than the reference chord E-GAM gives negative feedback. For example, if the user is supposed to play a C chord, but actually plays a C7 chord, the basic GAM algorithm, depending on the matching method and threshold, may consider this an acceptable match, whereas the E-GAM algorithm will find that the chord variation consisting of C, E, G and A# note types matches the played fragment better than the reference fragment representing the C chord, and therefore determine that the user played a wrong chord.

Notice, that in either case E-GAM does not need to find the optimal match for the input fragment. For practical purposes, if none of these 18 variations over the reference chord are better matches than the reference chord itself, it is likely that the reference chord is indeed the optimal match among more than 100,000 chords.

This may seem very surprising. Indeed, even if the reference chord is a better match than 18 of its neighboring chords, it does not follow that it is likely to be close to an optimal match among 100,000 chords. The statement may become clearer by negating it: if the optimal match for the played chord is not the reference chord, at least one of its 18 variations is likely to be a better match. To understand this, a worst-case example can be considered, where the optimal match does not contain any note types of the reference chord. Even in this case at least one of its variations will contain at least one note of similar type as the optimal chord and hence be very likely to return a closer match than the reference chord itself.

Conceptually speaking, choosing a search neighborhood of a chord to embrace variants with all 12 chromatic note types makes local maximums unlikely.

Bottom-Up Generative Audio Matching

Whereas the above methods can only give a positive or negative feedback, they can be improved to provide detailed feedback, e.g. about which chord has actually been played. For example, this information could be used to infer that the player almost played a guitar chord correctly, but missed the topmost string, or added a 7^{th} of a chord where not supposed to. This is very precise and useful feedback to the player.

It turns out that the E-GAM can be improved to find the best match among all chords by turning the local search into a global search and that it is feasible to do so on standard computers with some ingenious search heuristics, according to an embodiment of the invention.

Indeed the generative audio matching method is extremely successful applied incrementally in a bottom-up approach, hereafter BottomUp-GAM, which generates and matches chords from simple notes up to 5- or 6-note chords. In order to understand the central idea in Bottom Up-GAM, consider first the following oversimplification of it:

Match all simple note fragments against the player input. For a guitar, which may have 132 distinct notes, this means that 132 comparisons are made. The best match f1 is likely to be present in the played input chord.

Generate two-note chord constellations from f1 by adding another simple note. For a guitar this gives the following candidates: {f1,f2}, {f1,f3} . . . {f1, f132}. All candidates are matched against the player input. If the best single-note match f1 is better than the best two-note match, e.g. {f1, f7}, it is very likely that the player input is just the simple note f1 and the search can stop. Otherwise, the best two-note match is very likely to be present in the played input chord.

Generate and match three-note chord constellations by a procedure similar to the one described above for two-note chords. For a guitar, this may e.g. give the following candidates: {f1,f7,f2}, {f1,f7,f3} . . . {f1,f7,f132}.

This progresses incrementally until adding notes does not generate better matches. A maximum of four or five notes in a chord should be sufficient for most purposes, so the procedure can typically be stopped after having generated and matched 4- or 5-note chords.

The above procedure describes bottom-up generation and matching from a simple note up to many-note chord constellations. Conceptually speaking, it carries out local searches and finds a local optimum in the search space of all chords. The method can be extended to converge towards a global optimum by branching at each step, by the following modification of the above procedure:

At the end of the first step above, i.e. after having considered all single notes, instead of just picking the best single-note match, pick the two or three best single-note matches. For each of these three candidates, progress independently in a branch with the two-note step. Similarly, at the end of the two-note step, pick the two or three best single-note additions and progress independently in a branch with the three-note step. And so on.

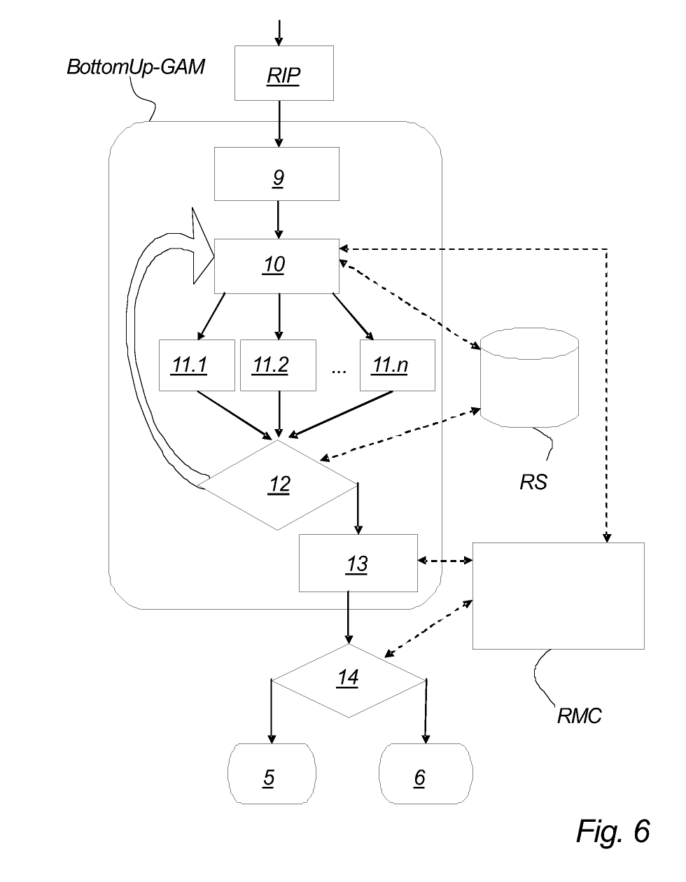

FIG. 6 illustrates BottomUp-GAM in more detail:

Step RIP: At the top of FIG. 6, the instrument audio is available through a real instrument processor RIP which continuously yields input audio fragments IAF in small time steps as described above. For each such time step, the algorithm runs as follows:

Step 9: Establish a working set of audio fragments W: the set of reference audio fragments that the algorithm works upon in a bottom-up fashion from simple note towards complex chords. Initially the current input audio fragment is matched against all simple note fragments of the reference storage RS. For a guitar, which may have 132 distinct notes, this is 132 audio matching comparisons. The audio fragments of the three best matches f1, f2, f3 are added to the working set W.

Step 10: For each of the audio fragments in the working set W, proceed to steps 11.1, 11.2, . . . 11.n respectively.

Step 11.1: Generate all chord constellations that can be obtained by adding a simple note from the reference storage to the working fragment. For example for a simple note working fragment for guitar f1, this gives the following candidates: {f1,f2}, {f1,f3} . . . {f1, f132}. All candidates are matched against the input audio fragment and the three best are added to the working set W.

Step 11.2: Generate all chord constellations that can be obtained by adding a simple note from the reference storage to the working fragment. For example for a simple note working fragment for guitar f2, this gives the following candidates: {f2,f1}, {f2,f3} . . . {f2,f132}. All candidates are matched against the input audio fragment and the three best are added to the working set W.

Step 11.n: Generate all chord constellations that can be obtained by adding a simple note from the reference storage to the working fragment. For example for a simple note working fragment for guitar fn, this gives the following candidates: {fn,f1}, {fn,f2} . . . {fn, f132}. All candidates are matched against the input audio fragment and the three best are added to the working set W.

Step 12: If the current best match in the working set W is a note or a chord fragment that consists of the same or fewer number of notes than all other fragments in the working set, no better match can be found and the bottom-up generation can end by going to step 13. Otherwise, the current best match is likely to be present in the player input, but it might be in a more complex chord so, more chords needs to be generated in a recursive fashion going to step 10 with a working set W, which is pruned for fragments that consist of fewer notes than the current best match.

Step 13: The best audio fragment match was found and it can be presented to the user. Other post-processing can occur. See descriptions below.

Step 14: If the best match corresponds to the reference music context RMC, go to step 6 to yield positive feedback to the player. Otherwise go to step 5 to yield negative feedback.

The above method does a three-way branching at every step in the recursion. In practice, the branching is necessary in the first two or three rounds to avoid ending in local maximums, but even with no branching after round three, the method has proven extremely accurate and robust while being computationally feasible for personal computers.

To ease the computational complexity, the method can take into account the topography of the instrument. For example, a guitar has 6 strings in particular tunings and each string can maximally contribute with one note to a chord. Likewise, a guitar has roughly 22 frets and the fingers of a guitarist cannot span over more than 5 or 6 frets. Given these facts it is possible to determine which chord constellations that are impossible or very unlikely to occur on e.g. a guitar, and the algorithm can skip generating and matching these constellations, or move them to the end of the process to only do them if an optimal chord is not found until then.

To further ease the computational complexity, all chord audio fragments, for example up to 4-note constellations, can be generated prior running the game system and stored in ROM, RAM or another storage medium. Also, since all audio generation and matching computations are vector computations and trivial to parallelize, they are perfectly suited for execution on GPU processing pipelines or on multi-core systems.

The BottomUp-GAM method has proven extremely accurate for electric and acoustic guitars. It recognizes all chords with very few errors. It recognizes and differentiates small variations over chords and has no problems with chords which sound very similar to even trained human ears, e.g. Am, Am7 and Fmaj7 played near the neck on a guitar. Generally, it even distinguishes and recognizes guitar chords, which are identical except for being played at different positions on a guitar fretboard. For example Am played near the neck of a guitar on the 5^{th} fret or the 12^{th} fret.

In virtue of the teaching method, which captures the intonation characteristics of each note, it can sometimes even distinguish between the exact same note or notes played on different strings—something completely out of range of traditional software based chord recognition approaches. At this task, physical solutions, such as MIDI Guitars, still have the upper hand but a trick can be used with GAM methods to make up for this: to mutually detune strings slightly, so that they are sounding slightly different, before the teaching process.

BottomUp-GAM can take advantage of the reference music context RMC in the same way as E-GAM to narrow its search space and ease the computational complexity. It can also use the reference music context in other ways to provide feedback to the player. For example, on a guitar fretboard the same notes can generally be transposed into several places and the reference music context provides hints that a recognized chord was played in a particular position on a guitar fretboard rather than another position which is also useful feedback to the player.

Variations Over Generative Audio Matching

Naturally, an alternative to the BottomUp-GAM, is a top-down approach, TopDown-GAM. As a starting point, TopDown-GAM matches entire chords, e.g., common major, minor, augmented and diminished chords and among the best matches, it incrementally subtracts or replaces notes to find even better matches.

As an example, consider the following generation system. As a starting point, generate 12 major, 12 minor, 12 augmented and 12 diminished chords and match each of them against the input audio fragment. From these 48 chords the 3 best ones are generated in 4 various octaves. From these 12 chords, the 3 best ones are taken and mutations are generated in various variations as described above for E-GAM. Then the best one is taken and generated in new variations iteratively until it converges on a best match, which is likely the optimal match.

More heuristics for generating chords can be applied. For example bottom-up and top-down approaches can be combined. Conceptually speaking, a big search space needs to be uncovered and common search heuristics can be applied, for example simulated annealing or genetic algorithms.

Generally, it is possible to improve the precision of the system by searching through a larger area of the search space or optimizing its structure. If needed, clustering algorithms, e.g. like k-means, can be used to cluster all chords in a high dimensional space to reduce the search space.

Instead of searching in generated variations over chords, a search space can be created prior to execution of the game systems, which could for example map all chords in to a high dimensional space based on their chromagrams. In such a map the distance between chords is a measure of chord similarity/dissimilarity and thus a matching function can simply return the distance between chords.

Variations Over Audio Matching Game Systems.

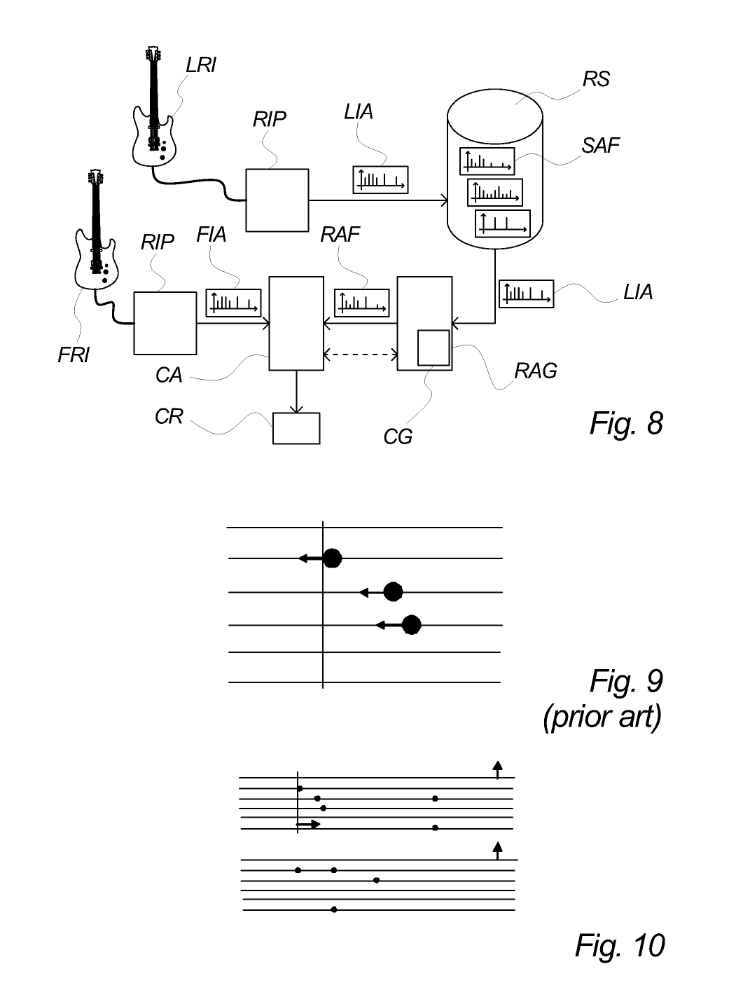

Unlike the GAM and E-GAM, which both rely on the reference music context in a symbolic note representation, i.e. reference music events, as a starting point for a local search, Bottom Up-GAM, can work with the reference music context RMC in any other representations like an audio representation, or indeed even entirely without it. This makes several variations of audio matching game systems possible and within the scope of the present invention. Two such variations are illustrated in FIG. 7 and FIG. 8.

FIG. 7 illustrates a game system with a reference music context in an audio representation, where two BottomUp-GAM instances run in parallel. The first instance recognizes a guitar player, playing along audio which is recognized by the second instance. Thus, the second instance is the reference music context of the first instance, which in all other aspects can work like in the simple case described above. With two or more instances, it becomes possible to obtain comparison results by alternative means than described above. For example, in the system in FIG. 7, at any small time step, each comparison algorithm CA instance yield a comparison result, which is an optimal match for the audio they recognize. Those comparison results can be compared to yield an overall similarity between the player and the audio he is supposed to play. The reference storage RS can be shared between the two instances or two separate reference storages can be used, for example if the two instances reside on different machines or network locations.

Since real instruments yield audio in the same way as the reference music audio, it is within the scope of the present invention that a game system can be setup among two players, in a teaching or a battling setup where one player try to match the audio of the other. Conceptually each player is the reference music context for the other.

It is within the scope of the present invention that the game system can be in non-real-time as well as real-time playing. In other words, the reference music audio of FIG. 7, can be a real instrument or a recording of a real instrument. Similarly, it can be the audio of a live music performance or a recording of a music performance.

FIG. 8 illustrates a similar game system where the reference music context is matched directly to the player input and has no dependencies upon symbolic music score. Thus, multiple players connected to the same game system, become the reference music context for each other, whether they play on a local machine or over a network of computers and regardless of whether they play along each other in real-time or their performance is recorded and in non-real-time. This setup is detailed further below.

Jam Session Game Systems.

Typically, music games provide a musical score that the player has to follow, and provide feedback based on the discrepancy between the musical score and the player performance.

With a real instrument recognition method, it is natural to feature jam session games, where the players on a variety of instruments either challenge each other in competition or cooperate to create real music. The aim is to make the players act not only as in a game but also as a band.

This kind of jam session games are in fact real jam sessions, in virtue of being played with real instruments producing real sound, and can be seen as ordinary jam sessions augmented with a software evaluation system which provides rules that constitute a game framework that the players must engage in, whether by collaboration or competition.

Such jam system augmentation software has never before been applicable or because only costly and inconvenient instrument specific hardware recognitions system have existed. The GAM-family of methods described above opens up a range of new instrument-generic jam-session game systems and makes new kinds of jam session augmentation possible. Some are detailed in the following. They are all variations over GAM-based recognition systems and differ mainly in the role of the players and control of reference music contexts RMC.

The jam session games become more entertaining and educational by mixing both pitched and non-pitched instruments. The GAM methods are unique in supporting both families of instruments. Pitched instruments, e.g. stringed, brass or wind instruments, produce notes and/or chords. Non-pitched instruments, e.g. percussion instruments, produce beats.

In a preferred embodiment, such jam session games comprise: A number of players on a variety of real musical instruments. Each player is plugged into a GAM-based recognition system and into the master mixer. Each player also has a speaker system or headphones, so that they can react to sound and may have a screen for visual feedback. A master mixer, whether hardware or software, which can regulate the outputs and routing of sound from any player to any player.

In the following simple jam session game systems are detailed. In order to do so, the following terminology is defined:
A player is said to play along another player when they produce similar notes and/or chord sequences. This can be determined by a GAM-based recognition setup like the ones shown in FIG. 7 and FIG. 8.
A player is said to be a lead, when he has the initiative that others have to follow.
A player is said to be following, when he is trying to follow the lead.
A player is said to be banned, when he is excluded from the jam.

With the above terminology in mind, various jam session game systems can be defined by simple game rules:

Improvisation Jam Session.
1. Player 1 is initially assigned status as lead. All other players are assigned as following.
2. Whenever a following player plays along the lead, he becomes lead, and other players becomes following.
3. A player who just achieved lead status keeps it for a minimum time frame, for example for 10 seconds.
4. The lead time is displayed on a screen. The total time a player is assigned lead can be seen as a measure of his performance.

Improvisation Jam Session with Banning.

The improvisation jam session game system above is extended with the following rule:
5. If a player does not achieve lead within a time span, for example a minute, he is banned from jam. The time span is displayed for each player as a countdown on a screen. A banned player's instrument output is turned off and he is excluded from the cycle above.

Battle Jam Session.
1. Each player gets a lead time interval in turns for a fixed time period, say 10 seconds.
2. When an interval is over, all other players are given a similar time period to repeat it in turns, according to the play-along definition above.
3. The similarity of the note and chord events of the lead and the repetitions is a measure of performance.

Improvisation Battle Jam Session.

Rule 2 and 3 above are substituted with:
2. When a period is over, the next player is given a similar time period to repeat it, according to the play-along definition above. A slider scaling form 0% similarity to 100% similarity is displayed on a screen.
3. The performance is measured after a scheme that gives most positive feedback for 50% similarity. This way each player use his playing time with a dual focus: to both answer the challenge of the previous player and to challenge the next player.

Teaching Jam Session.

Player 1, the teacher, maintains the lead status.

2. When the GAM recognize silence, i.e. a low-energy audio fragment, for a short while, e.g. 5 seconds, all other players, the students, are given a time period to repeat the lead in turns.
3. The students are rewarded after the similarity of their performance with the teacher's performance.

Song Jam Session.
Playing along songs is well known in music games. Instead of having players triggering music events which other players have to follow or respond to, all or some events are triggered by a real music score. In this game system, each player plays a track, i.e. an instrument line, of a song and his performance is evaluated accordingly.

A jam session setup according to an embodiment of the present invention is illustrated in FIG. 8. A lead real instrument LRI used by the lead player is used to produce lead input audio fragments LIA, which are stored in the reference store RS. A following real instrument FRI used by the following player is used to produce following input audio fragments FIA, which are matched with the lead input audio fragments presented to a comparison algorithm CA as reference audio fragments RAF by a reference audio generator RAG. A comparison result CR is generated and provided to one or more of the players. In general, and as described by the examples above, the lead input audio fragments are stored for later comparison with the following audio fragments, as the following player is not supposed to play concurrently with the lead player. In an alternative embodiment, the lead input audio fragments may be provided to the comparison algorithm by a different route than via a reference storage, and/or the lead input audio fragments may be exposed to processing before used for comparison. It is further noted that a preferred embodiment of the present invention enables geographical or logical distribution of the different elements, so that e.g. the lead real instrument LRI and the associated real instrument processor RIP may be positioned at an entirely different physical location, and being connected to the rest of the system by suitable means, preferably the Internet. Different variations may be suitable in such distributed systems, including e.g. having a reference storage in both locations for fast and reliable local retrieval of audio fragments, and where a kind of synchronization is performed between the several storages in order to maintain some or all of the stored audio fragments at several locations.

Feedback Mechanisms

Typically, music games adopt familiar game feedback mechanisms, such as visual effects, sound effects and a point system. For example, explosions are made when a note has been hit and points are given for the hit.

Point systems are familiar feedback in computer games, but in a real instrument game it is possible to provide new interesting feedback mechanisms, which not only provide feedback on the player's performance but also trigger events that make it easier for a player to learn to master an instrument and play a song.

The following new feedback mechanisms are very helpful for teaching to play a song. These feedback mechanisms have in common elegantly bridging feedback and difficulty control:

Dynamic Speed Change.
This feedback mechanism dynamically adjusts the speed of the music and game time based on the player's performance. Negative feedback slows down time. Positive feedback speeds up time.
This greatly improves the educational aspects of the game system because playing poorly will slow down time, which makes it easier to follow the song. Conversely, playing well speeds up time, making it harder to follow the song and thus the game system ensures that the player is constantly challenged.
With this feedback mechanism, the time it takes to get through a performance is a measure of how well it was played and how much the player should be rewarded.

Repeat Poor Passages.

This feedback mechanism uses repetition as a punishment for poor performance. Poor performance is detected as frequent negative feedback, and when poor performance occurs, time is rolled back for example four measures. Likewise, if the song data is segmented into sections (for example intro, verse, chorus, solo . . . ), performance can be evaluated on a section basis and time can be rolled back to the beginning of a section if it was unsatisfactorily performed.

Sound Feedback

This feedback mechanism use real time sound synthesizers and effects or mix in additional synthesized instrument harmonies into the sound output of the game. For example, good performance can trigger a reverb effects or an additional bass or guitar synthesizer playing the same notes as the player. Another interesting approach is to turn the volume down upon bad performance.

Another new feedback mechanism is made possible by so-called auto-tabbing, which is the process of automatically recording a player performance as a score or tablature rather than audio in real time. Because of the problems with chord recognition for guitars, only hardware based instrument-specific auto-tabbing systems (such as Midi Guitar based auto tabbing) have previously been possible. The GAM methods detailed above makes accurate auto-tabbing in software for a variety of traditional acoustic and electric instruments available.

Auto Tabbing Feedback.

During a performance, all recognized note and chord events are recorded as symbolic data, such as MIDI data. The recording can either be presented visually or played back by a synthesizer as feedback to the player, either in real time along the performance or at the end of the performance. The latter makes a good option for a player to evaluate his performance and find passages where he needs extra practice.

Visualization of Music

Even though the current invention only details how to match notes and chords, visualizing a full score in all its richness is important, because of its educational value and because it provides the player with detailed instructions of how to interpret a piece of music. The player may not get explicit feedback on how he interprets smaller details, like hammering rather than playing a specific note, but it is encouraging to have the full score presented rather than a simplification of it.

Real music score is rich on symbols. Notes might be the most important symbols, but current music games typically oversimplify the music score to a subset of real sheet music. Various kinds of visualizing of music score have appeared, most of which are incorporated in LittleBigStar, and they all have in common to use scrolling or movements of notes at the cost of readability. When notes move relatively fast over a screen, it is very difficult to read music symbols found on real music score sheets. Consequently, common music games only visualize a small subset of traditional music score, like notes and measures. See FIG. 9.

Oversimplified score is a barrier to the educational aspects of a music game. One solution to solve the readability problem is to slow down note movement, but this makes notes come closer together to a point where they are hard to distinguish and clutters the presentation.

Contrary, a preferred embodiment of the current invention uses a graphical presentation of music score, which is much closer to a traditional paper music score sheet. Instead of scrolling the notes, a time marker moves over the notes to indicate which notes and measures are being played. At the end of a row, the time marker jumps to the next row. The notes and symbols are almost as if static and real music notation is very readable. The entire music sheet scrolls slowly in order to make space for new lines of notes, but since it moves lines of notes of typically four measure bars it is so slow that it does not sacrifice readability. Thus real music score can be presented in all its richness. See FIG. 10.

In a preferred implementation, color-coding is also used to separate different sections of the music score and animations and effects like explosions are used to make some symbols recognizable and request attention from the player.

Some implementations of GAM methods detailed above does not need symbolic note data and if no such data is available, a rich musical score cannot be displayed. In this situation it is still possible to play along an audio or video stream, whether in a live playing setting or an offline recording, and a video stream can provide a good visualization of how to play the music, for example if recorded as a guitar player's left hand on the fretboard.

If symbolic note data is available and the player has a live camera recording a guitar fretboard, it is possible to use known techniques in the field of computer vision and augmented reality to make the notes to be played appear as lights or colored discs directly in the video stream of a guitar fretboard. This has the nice effect that the player can see the finger positions he needs to make along with his fingers in their actual positions in the same view. Augmented realty techniques often need special markers to track objects, but in the case of a guitar instrument, characteristic appearance of a fretboard, as a grid of frets and strings, makes markerless tracking possible.

What is claimed is:

1. Audio matching method for comparing an input audio fragment with reference audio fragment variants, said method being an incremental search method, comprising repeating the steps of:
obtaining a number of said reference audio fragments variants on the basis of one or more stored audio fragments from a reference storage; and
comparing said input audio fragment against said number of said reference audio fragment variants to determine a comparison result;
whereby said repetition of said steps is carried out a predetermined number of times or as long as said comparison result improves.

2. Audio matching method according to claim 1, whereby a reference audio fragment variant is obtained by mixing two or more of said stored audio fragments or by obtaining one of said stored audio fragments.

3. Audio matching method according to claim 1, whereby at least one of said stored audio fragments is selected from a list of:
note representing audio fragments,
note pluck sound representing audio fragments,
note sustain sound representing audio fragments,
chord representing audio fragments,
partial chord representing audio fragments, and
non-pitched sound representing audio fragments.

4. Audio matching method according to claim 3, whereby a reference audio fragment variant is obtained by mixing two or more note representing audio fragments to form a chord representing audio fragment.

5. Audio matching method according to claim 1, whereby the different repetitions of said step of obtaining said number of said reference audio fragment variants comprise either:
generating audio fragment variants for two-note chord constellations on the basis of said stored audio fragments representing simple notes;
generating audio fragment variants for three-note chord constellations on the basis of said two-note chord constellations; or
generating audio fragment variants for four-note chord constellations on the basis of said three-note chord constellations.

6. Audio matching method according to claim 1, whereby said incremental search method comprises bottom-up search heuristics.

7. Audio matching method according to claim 1, whereby one or more of said stored audio fragments are established in said reference storage by a learning process prior to carrying out said method.

8. Audio matching method according to claim 1, whereby said input audio fragment is derived from a real instrument.

9. Audio matching method according to claim 1, whereby said step of obtaining a number of said reference audio fragment variants is carried out in accordance with a reference music context.

10. Audio matching method according to claim 9, whereby said reference music context comprises reference music events comprising music score events determined by a symbolic representation of a piece of music.

11. Audio matching method according to claim 9, whereby said reference music context comprises reference music audio comprising an audio representation of music determined by a real music data stream from a digital medium.

12. Audio matching method according to claim 9, whereby said reference music context is determined from a lead input audio derived from a lead real instrument.

13. Audio matching method according to claim 9, whereby said method comprises a step of providing a representation of said comparison result to a user by performing a step of adjusting a rate at which subsequent reference music context is presented to said user.

14. Audio matching method according to claim 10, whereby said input audio fragment is derived from a real instrument and said method comprises the further steps of:
monitoring an audio signal from said real instrument to detect an onset,
upon detection of an onset, determining if it substantially coincides in time with one of said reference music events,
upon substantial coincidence in time between an onset and a reference music event, carrying out said steps of obtaining said reference audio fragment variants, and comparing said input audio fragment therewith to determine said comparison result.

15. Audio matching method according to claim 14, whereby said method, in case said comparison result fulfills a predetermined success criterion, comprises the further steps of:
generating a number of audio fragment variants on the basis of variants of said reference music event and said stored audio fragments,
comparing said input audio fragment against said audio fragment variants to determine a comparison result, and
providing a representation of said comparison result to a user.

16. Audio matching method according to claim 1, whereby said input audio fragment, said reference audio fragment variants and said stored audio fragments comprise fragments of music.

17. Use in a game system, of an audio matching method for comparing an input audio fragment with reference audio fragment variants, said method being an incremental search method, comprising repeating the steps of:
obtaining a number of said reference audio fragments variants on the basis of one or more stored audio fragments from a reference storage; and
comparing said input audio fragment against said number of said reference audio fragment variants to determine a comparison result;
whereby said repetition of said steps is carried out a predetermined number of times or as long as said comparison result improves.

18. Audio matching system comprising
a reference store comprising one or more stored audio fragments,
a reference audio generator arranged to establish one or more reference audio fragment variants on the basis of one or more of said stored audio fragments,
an input processor arranged to establish one or more input audio fragments, and
a comparison algorithm processor arranged to receive said input audio fragments and said reference audio fragment variants and determine a comparison result on the basis of a correlation thereof.

19. Audio matching system according to claim 18, wherein said reference audio generator cooperates with a chord generator to generate reference audio fragment variants representing chords by mixing stored audio fragments representing notes.

20. Audio matching system according to claim 18, further comprising a learning system arranged to store input audio fragments established by said input processor as stored audio fragments in said reference store.

21. Audio matching system according to claim 18, further comprising a reference music context, and wherein said reference audio generator is arranged to establish said one or more reference audio fragment variants on the basis of said reference music context and said one or more of said stored audio fragments.

22. Audio matching system according to claim 21, wherein said reference music context comprises reference music events comprising music score events determined by a symbolic representation of a piece of music.

23. Audio matching system according to claim 21, wherein said reference music context comprises reference music audio comprising an audio representation of music determined by a real music data stream from a digital medium.

24. Audio matching system according to claim 21, wherein said reference music context is determined from a lead input audio derived from a lead real instrument.

25. Audio matching system according to claim 18, wherein said input processor comprises a real instrument processor arranged to establish said one or more input audio fragments on the basis of an audio signal from a real instrument.

26. Audio matching system according to claim 18, wherein said one or more input audio fragments, said reference audio fragment variants and said one or more stored audio fragments comprise fragments of music.

27. Audio matching system according to claim 18, arranged to carry out an audio matching method for comparing said input audio fragment with said reference audio fragment variants, said method being an incremental search method, comprising repeating the steps of:
obtaining a number of said reference audio fragments variants on the basis of one or more stored audio fragments from a reference storage; and
comparing said input audio fragment against said number of said reference audio fragment variants to determine said comparison result;
whereby said repetition of said steps is carried out a predetermined number of times or as long as said comparison result improves.

28. Data carrier readable by a computer system and comprising instructions which when carried out by said computer system cause it to perform an audio matching method for comparing an input audio fragment with reference audio fragment variants, said method being an incremental search method, comprising repeating the steps of:
obtaining a number of said reference audio fragments variants on the basis of one or more stored audio fragments from a reference storage; and
comparing said input audio fragment against said number of said reference audio fragment variants to determine a comparison result;
whereby said repetition of said steps is carried out a predetermined number of times or as long as said comparison result improves.
